(19) United States
(12) Patent Application Publication
(10) Pub. No.: US 2005/0187810 A1
(43) Pub. Date: Aug. 25, 2005

(54) Ranking software product requirements using customer interest categories and supplier metrics

(75) Inventors: Vanadis Mack Crawford, Raleigh, NC (US); Angela Coble Pitts, Burlington, NC (US); Rosalind Toy Allen Radcliffe, Durham, NC (US); Leah Ann Seifert, Holly Springs, NC (US)

Correspondence Address: David R. Irvin;IBM Corporation T81/062, PO Box 12195, Research Triangle Park, NC, 27709, US

(73) Assignee: International Business Machines Corporation, Armonk, NY (US)

(21) Appl. No.: 10/782,645

(22) Filed: Feb. 19, 2004

(51) Int. Cl. G06F 17/60

(52) U.S. Cl. 705/10

(57) ABSTRACT

A method by which a supplier can rank software product requirements, an algorithm for determining the rankings, and computer program products for implementing the method and algorithm. A requirement is described with reference to customer interest categories. For each category, supplier metrics are evaluated, to provide partial scores. An overall score is then determined from the partial scores, and various products competing for common resources are ranked according to their overall scores.

### FIELD OF THE INVENTION

The invention pertains generally to the field of business methods, and more particularly to a method for ranking software product requirements such as application program enhancements, where the ranking takes into account categories that are descriptive of customers' interests and metrics that are descriptive of suppliers' interests.

### BACKGROUND

Suppliers that provide a wide range or products or services often experience conflicting product development requirements when allocating their finite resources. These requirements arise from the diverse and sometimes conflicting interests of established customers, new customers, and potential customers, as well as from general trends and technical progress in the field of business the supplier addresses. These external interests must be balanced against the supplier's own internal interests in profit and growth.

Typically, software suppliers chart a course that addresses predominately either the interests of their customers or their own internal interests, and pursue that course. In other cases, a supplier may attempt to balance the interests of both, but in an ad hoc way that often leads to the satisfaction of neither.

Thus, there is a need for a methodical way to rank software product requirements, so that, when conflicting requirements arise, resources may be invested in a way that balances the interests of the customer and the supplier so as to satisfy both to the greatest extent possible.

### SUMMARY

Aspects of the invention include a method by which a supplier can rank software product requirements, an algorithm for determining scores suitable for use in the rankings, and computer program products for implementing the method and algorithm.

Competing product requirements are ranked relative to each other, using customer interest categories that characterize the requirements from the customer's perspective, and supplier metrics that evaluate the requirements for each of the customer categories from the supplier's point of view. A requirement is described with reference to a set of customer interest categories. The requirement is then evaluated in each category according to the supplier metrics, to provide a partial score associated with that category. An overall score for the requirement is then determined from the partial scores. Competing product requirements are ranked according to their overall scores.

### BRIEF DESCRIPTION OF THE DRAWINGS

FIG. 1 is a flowchart that shows steps of a method for ranking software product requirements according to customer interest categories and supplier metrics.

FIG. 2 is a flowchart that shows a preferred implementation of the method of FIG. 1.

FIG. 3 shows an example in accordance with FIG. 2.

### DETAILED DESCRIPTION

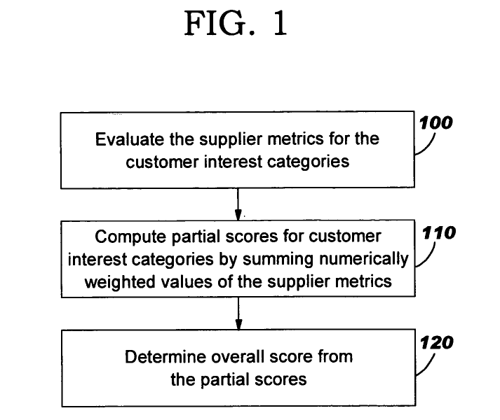

FIG. 1 shows steps of a method for ranking software product requirements according to customer interest categories and supplier metrics.

In a preferred embodiment of the invention, there are eight customer interest categories: capability, usability, performance, reliability, interoperability, maintainability, documentation, and serviceability. These categories are, however, illustrative of the invention rather than limiting; the scope of the invention includes the use of customer interest categories that are different from these, as well as subsets and supersets of these categories.

More particularly, in this exemplary embodiment of the invention, capability concerns the degree to which the product that is the subject of the requirement, once enhanced according to the requirement (which enhanced product is called simply the “product” herein below), has the necessary functions and features to perform as expected by the customer. Usability concerns the degree to which the customer can interact effectively with the product. This includes, but is not limited to, navigation, consistency, graphics and images, ease of installation, and ease of upgrade. Performance concerns the degree to which the response time or execution speed of the product meets the customer's expectations. Reliability concerns the degree to which the product is free from failures, malfunctions, errors, and other kinds of seemingly intermittent problems that adversely affect the proper execution of the customer's business. Interoperability concerns the degree to which the product can reasonably be expected to integrate usefully with other products that are used by the customer. Maintainability concerns the degree to which problems with the product can be diagnosed readily, fixes can be applied promptly, and new product releases can be brought up quickly. Documentation concerns the extent to which product-related publications such as installation and operation guides are accurate, complete, and easily retrieved. Serviceability concerns the extent to which fix management, such as problem determination, first-failure data capture, fix delivery and installation, and so forth, adversely affects the customer's conduct of business.

In a preferred embodiment of the invention, there are four supplier metrics. These are market penetration, priority as determined by the customer, revenue potential, and state of technology advancement. These supplier metrics are, however, illustrative of the invention rather than limiting; the scope of the invention includes the use of supplier metrics that are different from these, as well as subsets and supersets.

As shown in FIG. 1, the supplier metrics are evaluated for the customer interest categories (Step 100). Evaluations may be accordingly high, medium, low, or not immediately applicable, with corresponding numerical values of 3, 2, 1, and 0, respectively. Judgement that underpins the evaluations may be based on surveys, expert opinion, objective measurements, theoretical models, and the like.

An exemplary and preferred embodiment of the invention uses the following high-medium-low evaluation guidelines for the metrics: Market penetration is high if the product is used across most industry segments of the market, medium if the product is used in one or a few industry segments, and low if the product is used by a small number of customers. The customer-determined priority may be high if the product is critical to the customer's business, medium if the product is beneficial to the customer's business but not critical, and low if absence of the product has minimal effect. Revenue potential is high if the product opens a new market, medium if the product opens a new market segment, and otherwise low. Technology advancement is high if the technology underlying satisfaction of the product requirement is leading edge or newly invented, medium if the technology is industry standard, and low if the technology is mature.

It is not a requirement of the invention that the supplier metrics always be evaluated for every customer interest category. For example, a particular product requirement might be evaluated in terms of its capability, usability, and performance, but not the other customer interest categories. In this example, numerical values of the supplier metrics would be assigned for capability, usability, and performance, according to the aforementioned high-medium-low scheme. As a computational convenience to be described in further detail below, zero may be assigned as the numerical values of the supplier metrics across the other customer interest categories, as suggested above for categories that are not immediately applicable.

As shown in FIG. 1, a partial score is computed for each customer interest category by summing numerically weighted values of the supplier metrics for that category (Step 110). A preferred embodiment of the invention uses the following numerical weights: for the category “capability,” market penetration is weighted 0.30, customer priority is weighted 0.20, revenue potential is weighted 0.30, and technology advancement is weighted. 0.20. In the same order, the weights for usability are 0.10, 0.60, 0.10, 0.20; for performance, 0.20, 0.20, 0.20, 0.40; for reliability, 0.10, 0.40, 0.10, 0.40; for interoperability, 0.25, 0.25, 0.25, 0.25; for maintainability, 0.10, 0.60, 0.10, 0.20; for documentation, 0.00, 0.70, 0.10, 0.20; and for serviceability, 0.10, 0.60, 0.00, 0.30. These particular numerical values are, of course, illustrative of the invention rather than limiting.

As a running example, consider a hypothetical product requirement that is judged according to the customer interest categories “performance” and “reliability.” In this example, let the supplier metrics for performance be evaluated as high with respect to market penetration, high with respect to customer priority, medium with respect to revenue potential, and high with respect to technology advancement, giving respective numerical values of 3, 3, 2, 3; in like manner, let the supplier metrics for reliability be judged as medium with respect to market penetration, high with respect to customer priority, medium with respect to revenue potential, and low with respect to technology advancement, giving respective numerical values of 2, 3, 2, 1. In this example, the partial score for the performance category would be the sum of 0.20×3, 0.20×3, 0.20×2, and 0.40×3, for a total of 2.80. Likewise, the partial score for the reliability category would be the sum of 0.10×2, 0.40×3, 0.10×2, and 0.40×1, for a total of 2.00. For the other customer interest categories, the values of the supplier metrics would all be zero, and the corresponding partial scores for these other categories would therefore also all be zero.

As shown in FIG. 1, an overall score for the product requirement is determined from the partial scores (Step 120). In a preferred embodiment of the invention, the overall score is determined by finding the arithmetic average of the non-zero partial scores. In the foregoing example, the overall score for the product requirement in question would be the average of 2.80 and 2.00, which is 2.40. This overall score is then used to rank the product requirement in question with respect to other product requirements whose scores are found in the way just described.

Use of the arithmetic average to compute the overall score is illustrative of the invention rather than limiting. The overall score may be determined in a number of other ways as well. For example, the overall score may be the median partial score or median non-zero partial score, the geometric average of the non-zero partial scores, the average of the non-zero partial scores taken with outliers discarded, and so forth according to any number of ways known to those acquainted with data description techniques, all of which fall within the scope of the present invention.

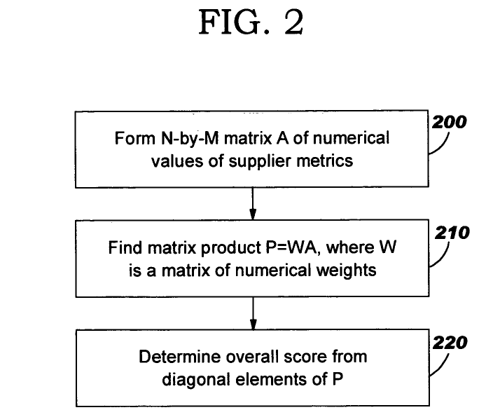

Another aspect of the invention is an efficient implementation algorithm based on matrix operations, as illustrated by FIG. 2. Let M be the number of customer interest categories, and N the number of supplier metrics. The numerical weights may then be described as an M-by-N matrix called W, whose element w(i,j) is the weight of supplier metric j for customer category i. In the running example introduced above, M is 8, N is 4, and w(3,4) is 0.40, which is the weight of the supplier metric “technology advancement” for the customer category “performance.”

The numerical values of the supplier metrics for a customer interest category may be represented as an N-by-1 column vector. There are M such column vectors, one for each customer interest category. In the running example introduced above, the column vectors for the customer interest categories “capability” and “usability” would be the transpose of (0, 0, 0, 0); the column vector for the category “performance” would be the transpose of (3, 3, 2, 3); the column vector for the category “reliability” would be the transpose of (2, 3, 2, 1); and the column vectors for the remaining four customer interest categories would all be the transpose of (0, 0, 0, 0). The M column vectors may then be aggregated to form an N-by-M matrix called here A (Step 200).

Partial scores are then computed by finding the matrix product P=WA (Step 210). Partial scores then appear as the elements of the principal diagonal of P. Since only the diagonal elements are of interest here, it is not necessary, of course, to compute the full matrix product. Rather, only the elements of the principal diagonal need to be found. The full matrix product may be computed, however, if it is convenient to do so when using standard mathematical software application programs; both approaches fall within the scope of the invention. The overall score is then determined from the diagonal elements of P (Step 220), which diagonal elements are the partial scores. The overall score may be determined as described above, for example, by taking the arithmetic average, or by performing equivalent operations on the diagonal elements of P as described above.

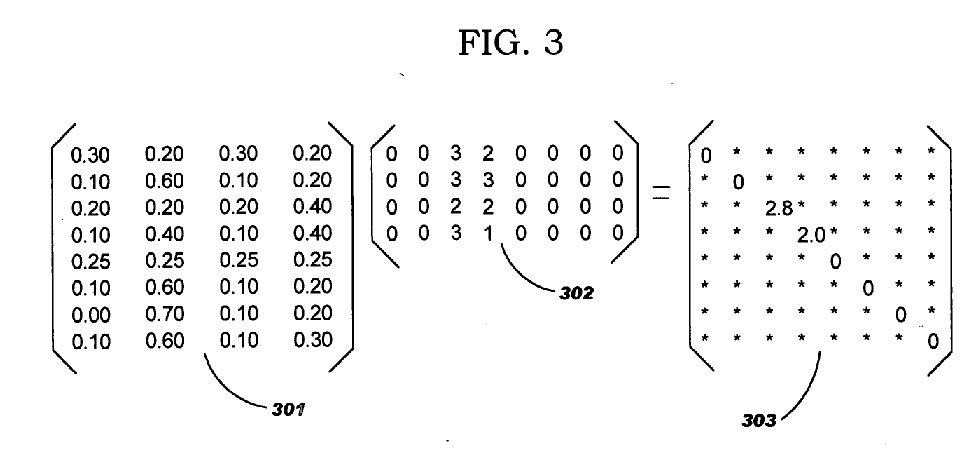

FIG. 3 shows the matrices W (301), A (302), and P (303), formed as described above, using the numerical values of the running example. In this illustration, only the diagonal elements of P have been computed, as only these are of interest; the other elements of P are shown as asterisks in FIG. 3.

Thus, the present invention provides a convenient, efficient, and methodical way of ranking software product requirements, taking into account both the customer's and the supplier's needs. The aforementioned description of the invention is illustrative rather than limiting, however, and the scope of the invention is limited only by the appended claims.

1. A method for determining numerical scores suitable for use in ranking software product requirements, comprising the steps of:
evaluating supplier metrics for customer interest categories to provide numerical values for a software product requirement;
computing partial scores for the customer interest categories by weighting and summing the numerical values; and
determining an overall score for the software product requirement from the partial scores.

2. The method of claim 1, wherein the customer interest categories are selected from the set consisting of capability, usability, performance, reliability, interoperability, maintainability, documentation, and serviceability.

3. The method of claim 1, wherein the supplier metrics are selected from the set consisting of market penetration, priority as determined by a customer, revenue potential, and state of technology advancement.

4. The method of claim 1, wherein the step of determining includes a step of averaging non-zero partial scores.

5. A method for determining numerical scores suitable for use in ranking software product requirements, comprising the steps of:
forming an N by M matrix A of numerical values of supplier metrics for customer interest categories of a software product requirement, where N is a number of supplier metrics and M is a number of customer interest categories;
multiplying the matrix A by an M by N matrix of numerical weights W, to form the M by M matrix P=WA, to provide partial scores; and
determining an overall score for the software product requirement from diagonal elements of the matrix P.

6. The method of claim 5, wherein the customer interest categories are selected from the set consisting of capability, usability, performance, reliability, interoperability, maintainability, documentation, and serviceability.

7. The method of claim 5, wherein the supplier metrics are selected from the set consisting of market penetration, priority as determined by a customer, revenue potential, and state of technology advancement.

8. The method of claim 5, wherein the step of determining includes a step of averaging non-zero diagonal elements of P.

9. A program storage device readable by a machine, tangibly embodying a program of instructions executable by the machine to perform method steps for determining numerical scores suitable for use in ranking software product requirements, said method steps comprising:
evaluating supplier metrics for customer interest categories to provide numerical values for a software product requirement;
computing partial scores for the customer interest categories by weighting and summing the numerical values; and
determining an overall score for the software product requirement from the partial scores.

10. The program storage device of claim 9, wherein the customer interest categories are selected from the set consisting of capability, usability, performance, reliability, interoperability, maintainability, documentation, and serviceability.

11. The program storage device of claim 9, wherein the supplier metrics are selected from the set consisting of market penetration, priority as determined by a customer, revenue potential, and state of technology advancement.

12. The program storage device of claim 9, wherein the step of determining includes a step of averaging non-zero partial scores.

13. A program storage device readable by a machine, tangibly embodying a program of instructions executable by the machine to perform method steps for determining numerical scores suitable for use in ranking software product requirements, said method steps comprising:
forming an N by M matrix A of numerical values of supplier metrics for customer interest categories of a software product requirement, where N is a number of supplier metrics and M is a number of customer interest categories;
multiplying the matrix A by an M by N matrix of numerical weights W, to form the M by M matrix P=WA, to provide partial scores; and
determining an overall score for the software product requirement from diagonal elements of the matrix P.

14. The program storage device of claim 13, wherein the customer interest categories are selected from the set consisting of capability, usability, performance, reliability, interoperability, maintainability, documentation, and serviceability.

15. The program storage device of claim 13, wherein the supplier metrics are selected from the set consisting of market penetration, priority as determined by a customer, revenue potential, and state of technology advancement.

16. The program storage device of claim 13, wherein the step of determining includes a step of averaging non-zero diagonal elements of P.
